(19) United States
(12) Patent Application Publication
(10) Pub. No.: US 2022/0386668 A1
(43) Pub. Date: Dec. 8, 2022

(54) FOOD COMPOSITION

(71) Applicants: SUMITOMO CHEMICAL COMPANY, LIMITED, Tokyo (JP); TOMBOW BEVERAGE CO. LTD., Toyama-shi, Toyama (JP)

(72) Inventors: Akihiro YAMAMORI, Kawasaki-shi (JP); Katsunori SASAKI, Tokyo (JP); Maki TOMINAGA, Toyama-shi (JP)

(73) Assignees: SUMITOMO CHEMICAL COMPANY, LIMITED, Tokyo (JP); TOMBOW BEVERAGE CO. LTD., Toyama-shi, Toyama (JP)

(21) Appl. No.: 17/770,873

(22) PCT Filed: Oct. 23, 2020
(86) PCT No.: PCT/JP2020/039812

§ 371 Date: Apr. 21, 2022

(30) Foreign Application Priority Data
Oct. 25, 2019 (JP) 2019-193977

(51) Int. Cl. A23L 33/105; A23L 27/30; A23L 21/10; A23L 27/00

(52) U.S. Cl. CPC A23L 33/105; A23L 27/34; A23L 21/10; A23L 27/82; A23V 2002/00

(57) ABSTRACT

Disclosed is a jelly-like food composition comprising an extract of a Kampo bulk drug, a sweetening agent, a gelling agent, an acidulant, and a flavor.

### TECHNICAL FIELD

The present invention relates to a food composition.

### BACKGROUND ART

Preventive medicine is required to improve the quality of life (QOL) and healthcare costs of citizens. In order to achieve preventive medicine, early detection and early treatment are required, and there is a growing interest in self-medication, where individuals can take early action on their own when they are aware of subjective symptoms.

In recent years, with the increasing availability of health-related information on the internet, sensors for long-term continuous monitoring of health conditions, and medical questionnaires published on the internet, it has become easier for people to notice abnormalities in their own health conditions without having to visit a hospital.

Kampo medicines are products that are modified in Japan based on products empirically invented using different types and ratios of crude drugs in ancient China, and the efficacy of Kampo medicines has recently been proved by scientific methods. Some of the components of Kampo medicines are taken on a daily basis as food. If a Kampo medicine is taken at an early stage, an early improvement can be expected.

On the other hand, since most Kampo medicines need to be prescribed by a doctor, it is difficult for healthy people to use them for self-medication, in which they can easily obtain and take Kampo medicines without going to a hospital when they are slightly aware of something wrong with their body.

Many Kampo extracts have bitterness or pungency. In order to improve the bitterness of shosaikoto, a technique of adding a gelling agent and a sweetening agent has been published; and to improve bitterness and pungency, encapsulation, sugar coating, and the like have been used. However, if most of the bitterness is masked, or strong flavor or pungent taste is lost by encapsulation, sugar coating, etc., a Kampo extract may be administered in a large quantity.

Patent Literature 1 reports on a liquid diet containing a Kampo preparation formulation. It states that the liquid diet is easier to take, and that the addition of milk protein concentrate improves flavor, and prevents unpleasant taste and smell from remaining in the mouth after administration.

Patent Literature 2 reports that by making a Kampo preparation semi-solid using gelatin, it is possible to take the Kampo preparation without water, without worrying about its bitterness.

Patent Literature 3 discloses a granular jelly beverage for medication used for taking a crude drug and/or Kampo medicine, comprising a bitterness-masking ingredient, a bitterness-masking auxiliary ingredient, an aggregation-inhibiting gelling ingredient, a taste-adjusting ingredient, and water. Patent Literature 3 also discloses that the beverage is able to mask the bitterness of a drug and to coat the drug such that the drug can be readily swallowed.

However, with the techniques of Patent Literature 1 to 3, if the taste is good and the dosability is overly high, the drug may be taken in a large quantity.

### CITATION LIST

### Patent Literature

PTL 1: JP2007-28997A
PTL 2: JP1993-43474A
PTL 3: WO2009/047859

### SUMMARY OF INVENTION

### Technical Problem

Some of the components of Kampo medicines are already used as food, and are not exclusively pharmaceutical products. Examples thereof include ginger and processed ginger, Zanthoxylum fruit and Zanthoxylum bungeanum, Glycyrrhiza, jujube, wheat, and Platycodon root. Extracts that contain these components in proportions defined as Kampo medicines can be used as food.

When Kampo extracts are formed into food, there are problems of irritating sensations to the tongue such as bitterness and pungency, and the persistence thereof.

Accordingly, taking Kampo medicines with their original taste and in their original form is uncomfortable. However, Kampo medicines may be taken in a large quantity if their bitterness or pungency is gone.

The present invention aims to provide a food composition containing an extract of a Kampo bulk drug, wherein the food composition is easy to take orally while retaining a moderate amount of the bitterness and pungency unique to the Kampo bulk drug.

### Solution to Problem

The present inventors conducted extensive research to solve the above problem, and consequently found that a food composition having excellent dosability while retaining a moderate amount of bitterness and pungency can be produced by combining an extract of a Kampo bulk drug with a sweetening agent, a gelling agent, an acidulant, and a flavor.

The present invention was accomplished by conducting further research based on this finding. The present invention provides the following jelly-like food composition.

Item 1. A jelly-like food composition comprising an extract of a Kampo bulk drug, a sweetening agent, a gelling agent, an acidulant, and a flavor.
Item 2. The food composition according to Item 1, wherein the Kampo bulk drug is at least one member selected from the group consisting of daikenchuto, kanbakutaisoto, kanzokankyoto, kikyoto, and hainoto.
Item 3. The food composition according to Item 1 or 2, comprising two or more sweetening agents.
Item 4. The food composition according to any one of Items 1 to 3, comprising a sugar alcohol and/or a sugarcane extract as the sweetening agent.
Item 5. The food composition according to any one of Items 1 to 4, wherein the amount of the sweetening agent is 5 mass % or more.

### Advantageous Effects of Invention

The present invention can provide a food composition comprising an extract of a Kampo bulk drug, wherein the food composition is easy to take orally while retaining a moderate amount of bitterness and pungency unique to the Kampo bulk drug. By thus forming the Kampo extract into a food, even healthy people can take the Kampo extract; and since the bitterness and pungency unique to the Kampo bulk drug are retained in a moderate amount, ingestion in an appropriate amount is possible.

### DESCRIPTION OF EMBODIMENT

The embodiments of the present invention are explained below.

In the present specification, the expressions “comprise” encompasses the concepts of consisting essentially of and consisting of.

The jelly-like food composition of the present invention comprises an extract of a Kampo bulk drug, a sweetening agent, a gelling agent, an acidulant, and a flavor.

### Kampo Bulk Drug

The food composition of the present invention comprises an extract of a Kampo bulk drug as a main component. Rather than a single crude drug extract, the Kampo bulk drug extract is a mixture of crude drug extracts described in the Japanese Pharmacopoeia, the standards for marketing approval of over-the-counter (OTC) Kampo products, or past literature of Japanese, Chinese, and other medical books, such as, “Jingui Yaolüe” and “Shang Han Lun.” The extract of the Kampo bulk drug may be used in liquid, viscous extract, or dried extract form. Examples of the extract include those obtained by extracting crude drugs with water, then concentrating the resultant, and performing filtration by adding a specific amount of ethanol, water, or hydrous ethanol, followed by concentration, according to the method for producing Glycyrrhiza extracts according to the Japanese Pharmacopoeia; and those obtained by low-temperature extraction with water or hydrous ethanol.

The amount of an extract of a Kampo bulk drug in the jelly-like food composition of the present invention is preferably 0.1 to 50 mass %, and more preferably 10 to 40 mass % from the viewpoint of dosability of the Kampo bulk drug.

The Kampo bulk drug is not particularly limited as long as it consists of a starting material used as food rather than a pharmaceutical product. Examples include daikenchuto, kanbakutaisoto, kanzokankyoto, kikyoto, and hainoto. Since one of the characteristics of the present invention is to retain a moderate amount of bitterness and pungency, Kampo bulk drug having bitterness and/or pungency can be preferably used, and those having both bitterness and pungency are particularly preferred.

For example, daikenchuto is described in “Jingui Yaolüe,” a clinical book from the Chinese Song Dynasty. It is considered to have, for example, effects of enhancing intestinal motility, inhibiting excessive intestinal motility, inhibiting ileus, and increasing the intestinal blood flow, as well as anti-inflammatory effects. Daikenchuto is usually obtained by using an extract in a powder form of a crude drug mixture consisting of 2.0 g of Zanthoxylum fruit or Zanthoxylum bungeanum, 3.0 g of ginseng, and 5.0 g of Zingiber siccatum (sometimes also called Mukoi-Daikenchuto), to which a powdered candy (Saccharum granorum (koi), maltose) in an amount that is about 8 times the amount of the extract is blended. Daikenchuto is usually formulated from Zanthoxylum fruit or Zanthoxylum bungeanum:ginseng:Zingiber siccatum:Saccharum granorum in a mass ratio of 2.0:3.0:5.0:20.

### Sweetening Agent

The food composition of the present invention contains a sweetening agent to further improve ingestion sensation. The sweetening agent means an additive used for the purpose of imparting a sweet taste to food.

The sweetening agent can make a product having bitterness and pungency, such as a Kampo bulk drug extract, easier to take. The sweetening agent is not particularly limited, and examples include glucose, sucrose, lactose, maltose, high-fructose corn syrup, starch syrup, fructose, palatinose, erythritol, sorbitol, maltitol, reduced starch syrup, oligosaccharide, trehalose, sugarcane extract, stevia, acesulfame K, somatin, sucralose, advantame, neotame, Siraitia grosvenorii, aspartame, and xylitol. A sugar alcohol and a sugarcane extract are preferred since they do not completely mask bitterness and pungency; and sucralose, acesulfame K, and somatine are also preferred. The sweetening agents can be used alone or in a combination of two or more. The sweetening agents are desirably used in a combination of two or more.

The amount of the sweetening agent in the jelly-like food composition of the present invention is not particularly limited, and is preferably 5 mass % or more, more preferably 6 mass % or more, and still more preferably 7 mass % or more; and preferably 30 mass % or less, more preferably 20 mass % or less, and still more preferably 15 mass % or less.

More specifically, the amount of the sugar alcohol is preferably 1 to 20 mass %, and more preferably 3 to 15 mass %. The amount of the sugar cane extract is preferably 0.001 to 0.1 mass %, and more preferably 0.01 to 0.05 mass %.

The amount of the sweetening agent in the jelly-like food composition of the present invention is preferably 0.01 to 2 parts by mass, and more preferably 0.1 to 1 part by mass, per part by mass of the Kampo bulk drug extract.

### Gelling Agent

The food composition in the present invention contains a gelling agent for the purpose of making the composition jelly-like, thus reducing the spread of bitterness in the mouth and making the food composition easier to eat. Various known gelling agents can be used as a gelling agent. Since appropriate storage stability is required, a gelling agent other than gelatin is preferred. Preferable examples of the gelling agent include carrageenan, locust bean gum, xanthan gum, konjac imo (konjac yam) extract, polyacrylic acid, gellan gum, psyllium seed gum, tara gum, gum Arabic, pullulan, guar gum, agar, pectin, and alginic acid. Gelling agents can be used alone or in a combination of two or more.

The amount of the gelling agent in the jelly-like food composition of the present invention is not particularly limited, and is preferably 0.01 to 5 mass %, and more preferably 0.1 to 3 mass %.

The amount of the gelling agent in the jelly-like food composition of the present invention is preferably 0.001 to 1 part by mass, and more preferably 0.01 to 0.5 parts by mass per part by mass of the Kampo bulk drug extract.

### Acidulant

The food composition in the present invention contains an acidulant to further improve ingestion sensation. The acidulant is used for adding acidity so that a person can easily take the bitterness and pungency of the Kampo bulk drug extract. The acidulant is not particularly limited, and examples include citric acid, citric anhydride, sodium citrate, malic acid, acetic acid, tartaric acid, fumaric acid, ascorbic acid, gluconic acid, succinic acid, lactic acid, and phosphoric acid. Acidulants can be used alone or in a combination of two or more.

The amount of the acidulant in the jelly-like food composition of the present invention is not particularly limited, and is preferably 0.01 to 3 mass %, and more preferably 0.1 to 1 mass %.

The amount of the acidulant in the jelly-like food composition of the present invention is preferably 0.001 to 0.1 parts by mass, and more preferably 0.01 to 0.05 parts by mass per part by mass of the Kampo bulk drug extract.

### Flavor

The food composition in the present invention contains a flavor to further improve ingestion sensation. The flavor is used to make the smell unique to the Kampo bulk drug easier to take by the addition of the acidulant and the flavor. The acidulant and the flavor can be added at the same time. The flavor is not particularly limited as long as it reproduces a tart plant flavor. Examples include fruit or spice flavors such as citrus flavors (yuzu, oranges, and lemons), fruit flavors (fruits other than citrus, such as apples, grapes, and peaches), yoghurt flavors, mint flavors (peppermint and Japanese mint), spice flavors (ginger and cinnamon), and sweet flavors (honey and sugar). The flavors can be used alone or in a combination of two or more.

When a sweet flavor is used as a flavor in a very pungent and bitter food composition, a person will find the food composition more pungent and bitter after ingestion; accordingly, slightly pungent or bitter flavors are desirable, and citrus-based, mint-based, and spice-based flavors are preferable. Further, of Kampo bulk drugs, for those containing Zingiber siccatum, the image of the ingredient matches the flavor; accordingly, the use of ginger flavor is particularly preferable.

The amount of the flavor in the jelly-like food composition of the present invention is not particularly limited, and is preferably 0.01 to 5 mass %, and more preferably 0.1 to 2 mass %.

The amount of the flavor in the jelly-like food composition of the present invention is preferably 0.001 to 1 part by mass, and more preferably 0.01 to 0.1 parts by mass, per part by mass of the Kampo bulk drug extract.

As the extract of a Kampo bulk drug, sweetening agent, gelling agent, acidulant, and flavor in the food composition of the present invention, commercially available products can be used.

### Others

In addition to the extract of a Kampo bulk drug, a sweetening agent, a gelling agent, an acidulant, and a flavor, a preservative may be added to the food composition of the present invention. Examples of the preservative include, without limitation, benzoic acid, sodium benzoate, ethyl p-hydroxybenzoate, propyl p-hydroxybenzoate, and butyl p-hydroxybenzoate.

The food composition of the present invention usually contains water, and water is not limited as long as water is drinkable. Examples include tap water, ground water, distilled water, purified water, and ion exchange water.

The food composition of the present invention can further include, as necessary, vitamins, minerals, flavonoids, amino acids, nucleic acids, fatty acids, fresheners, coloring agents, stabilizers, and surfactants.

### Food Composition

The “food composition” in the present invention encompasses the meanings of health food, functional food, dietary supplement, supplement, food with health claims (e.g., food for specified health uses, food with nutrient function, and food with functional claims), food for special dietary uses (e.g., food for infants, food for pregnant and nursing women, food for the sick), and the like.

The form of the food composition of the present invention is not particularly limited. The food composition may be in the form of a semi-liquid or gel, or solid. The shape of the food composition of the present invention is not particularly limited. Examples include plate, cube, rectangle, ellipsoidal sphere, sphere, triangular pyramid, quadrangular pyramid, and the like.

The method for producing the food composition of the present invention is not particularly limited, and can be prepared according to the conventionally known method. The food composition can be produced using, for example, known production equipment. For example, the food composition can be prepared by dispersing a gelling agent, which is the base for making the food composition a jelly-like composition, in a dispersing medium at an appropriate temperature; dispersing an extract of a Kampo bulk drug while adjusting the temperature; further mixing the resultant with a sweetening agent, acidulant, and flavor; and then cooling the mixture to form a gel.

The container for containing the food composition of the present invention is not particularly limited as long as the container contains a certain amount of the food composition. Examples include pouches, cups, soft packs, cans, and bottles.

The jelly-like food composition of the present invention has excellent properties of being easily orally ingested while retaining the bitterness and pungency unique to the Kampo bulk drug. Thus, making a Kampo extract available as food allows even healthy people to ingest it; however, since the bitterness and pungency unique to the Kampo bulk drug is retained in a moderate amount, people can take an appropriate amount of the composition. Accordingly, making the Kampo extract into food using the jelly-like food composition of the present invention improves availability for healthy people, thus contributing to the realization of preventive medicine.

### Examples

The present invention is explained in detail below with reference to the Examples. However, the present invention is not limited to these Examples.

### Preparation of Sample

Using a Kampo bulk drug extract having the formulation shown in Table 1, components were added in the amounts shown in Table 1, and purified water was added in an appropriate amount so that 100 g of a mixture was obtained. Thereafter, a jelly-like composition was prepared according to an ordinary method, thus obtaining samples of Examples 1 to 3 and Comparative Examples 1 and 2. The gelling agent shown in Table 1 was produced by combining locust bean gum, carrageenan, xanthan gum, and a konjac imo extract.

TABLE 1

| | Amount (g) | | | | |
|---|---|---|---|---|---|
| | Exam- | Exam- | Exam- | Comparative | Comparative |
| | ple 1 | ple 2 | ple 3 | Example 1 | Example 2 |
| Name of | Daikenchuto | | | | |
| Kampo bulk | | | | | |
| drug extract | | | | | |
| Kampo bulk | 30 | 30 | 15 | 30 | 30 |
| drug extract | | | | | |
| Erythritol | 7 | 10 | 10 | — | — |
| Citric acid | 0.45 | 0.48 | 0.31 | — | 0.45 |
| (anhydrous) | | | | | |
| Gelling agent | 1.5 | 1.5 | 1.5 | — | 1.5 |
| Sucralose | 0.034 | 0.034 | 0.034 | — | — |
| Acesulfame K | 0.034 | 0.034 | 0.034 | — | — |
| Thaumatin | 0.1 | 0.1 | 0.1 | — | — |
| Sugarcane | 0.02 | 0.02 | 0.02 | — | — |
| extract | | | | | |
| Yuzu flavor | 0.5 | 0.65 | 0.65 | — | — |

### Sensory Evaluation

The sensory evaluation regarding bitterness and pungency was conducted on the obtained jelly-like compositions (Examples 1 to 3 and Comparative Examples 1 and 2) by 8 panelists according to evaluation criteria shown in Tables 2 and 3 below. The results were obtained as the average of the evaluation scores of eight panelists.

“No pungency or bitterness” means a taste with no or little pungency or bitterness, and a taste that a person is comfortable with taking in more than one prescribed dose. “Moderate pungency or bitterness” means a taste with pungency or bitterness, and a taste that a person can take in a prescribed dose, but is uncomfortable with taking another prescribed dose. “Excessive pungency and bitterness” means a taste that a person is uncomfortable with taking in a prescribed dose, and “extremely excessive pungency and bitterness” means a taste that a person finds unpleasant due to the strong taste when taking the prescribed dose.

TABLE 2

| Evaluation items of stimulation to | Evaluation |
|---|---|
| tongue (pungency) | score |
| No pungency | 0 |
| Feels moderate pungent | 1 |
| Feels excessively pungent | 2 |
| Feels extremely excessively pungent | 3 |

TABLE 3

| Evaluation items of stimulation to | Evaluation |
|---|---|
| tongue (bitterness) | score |
| No bitterness | 0 |
| Moderate bitterness | 1 |
| Feels excessively bitter | 2 |
| Feels extremely excessively bitter | 3 |

The results of the sensory test are shown in Table 4. In Examples 1 to 3, it was found that the pungency and bitterness scores were close to 1, and that moderate pungency and bitterness existed as compared to the Comparative Examples.

TABLE 4

| | Exam- | Exam- | Exam- | Comparative | Comparative |
|---|---|---|---|---|---|
| | ple 1 | ple 2 | ple 3 | Example 1 | Example 2 |
| Pungency | 1.4 | 1.3 | 1 | 3 | 2.3 |
| Bitterness | 0.9 | 0.8 | 0.9 | Unmeasurable | 1.5 |
| | | | | due to | |
| | | | | overly strong | |
| | | | | pungency | |

### INDUSTRIAL APPLICABILITY

The present invention can provide a food composition comprising an extract of a Kampo bulk drug, wherein the food composition is easy to take orally, while retaining a moderate amount of the bitterness and pungency unique to the Kampo bulk drug, and the availability thereof is improved as compared to Kampo medicines.

1. A jelly-like food composition comprising an extract of a Kampo bulk drug, a sweetening agent, a gelling agent, an acidulant, and a flavor.

2. The food composition according to claim 1, wherein the Kampo bulk drug is at least one member selected from the group consisting of daikenchuto, kanbakutaisoto, kanzokankyoto, kikyoto, and hainoto.

3. The food composition according to claim 1, comprising two or more sweetening agents.

4. The food composition according to claim 1, comprising a sugar alcohol and/or a sugarcane extract as the sweetening agent.

5. The food composition according to claim 1, wherein the amount of the sweetening agent is 5 mass % or more.
